(19) United States
(12) Patent Application Publication
(10) Pub. No.: US 2025/0139374 A1
(43) Pub. Date: May 1, 2025

(54) AUTOMATED EVALUATION OF LARGE LANGUAGE MODELS

(71) Applicant: Intuit Inc., Mountain View, CA (US)

(72) Inventors: Wendi CUI, Shenyang (CN); Jiaxin ZHANG, Mountain View, CA (US); Damien LOPEZ, San Diego, CA (US); Colin RYAN, Mountain View, CA (US)

(73) Assignee: Intuit Inc., Mountain View, CA (US)

(21) Appl. No.: 18/934,210

(22) Filed: Oct. 31, 2024

Related U.S. Application Data
(60) Provisional application No. 63/594,886, filed on Oct. 31, 2023.
(60) Provisional application No. 63/594,888, filed on Oct. 31, 2023.

(51) Int. Cl. G06F 40/30

(52) U.S. Cl. CPC G06F 40/30

(57) ABSTRACT

Providing an output of a primary large language model to a criteria model including a second large language model. The criteria model compares each of the sentences to a reference source and generates a first data structure including a first vector. The first vector stores, for each of the sentences, a corresponding evaluation of a given sentence as being consistent or inconsistent with the reference source, and a corresponding reason for the corresponding evaluation of the given sentence. The first data structure is provided to a converter model including a third large language model. The converter model converts the first data structure to a second data structure. The second data structure includes a second vector storing scores indicating a corresponding consistency value for each of the sentences. A metric, indicating an overall consistency of the output with respect to the reference source, is generated from the second data structure.

### CROSS-REFERENCE TO RELATED APPLICATIONS

This application claims priority to U.S. Provisional Patent Application No. 63/594,886, filed Oct. 31, 2023, the entirety of which is hereby incorporated by reference; and this application also claims priority to U.S. Provisional Patent Application No. 63/594,888, filed Oct. 31, 2023, the entirety of which is hereby incorporated by reference. This application is also related to U.S. Application Ser. No. ______, also identified by attorney docket number 2413008US; 758999 INU-907, filed on the same date as the present application.

### BACKGROUND

Large language models sometimes generate results that may be deemed unexpected, unreasonable, or wrong by a human evaluator. For example, the output of the model may be a statement which appears to have little to do with the subject matter of the prompt, or which goes against conventional understanding of a rational response. Such unexpected large language model responses colloquially may be referred to as “hallucinations” of the large language model, though of course a large language model is incapable of hallucinating in the normal sense of the word. Nevertheless, a technical problem exists in that it is desirable to mitigate or eliminate such unexpected large language model responses, or at least to recognize such responses immediately. Recognizing unexpected large language model responses may prevent additional errors, such as when the large language model response is to be used by other algorithms that use the large language model response as input.

### SUMMARY

One or more embodiments provide for a method. The method includes providing an output of a primary large language model to a criteria model including a second large language model. The output includes sentences. The method also includes comparing, by the criteria model, each of the sentences to a reference source. As a result of comparing, the criteria model generates a first data structure including a first vector. The first vector stores, for each of the sentences, a corresponding evaluation of a given sentence as being consistent or inconsistent with the reference source, and a corresponding reason for the corresponding evaluation of the given sentence. The method also includes providing the first data structure to a converter model including a third large language model. The method also includes converting, by the converter model, the first data structure to a second data structure. The second data structure includes a second vector storing scores indicating a corresponding consistency value for each of the sentences. The method also includes generating, from the second data structure, a metric indicating an overall consistency of the output with respect to the reference source.

One or more embodiments also provide for a system. The system includes a computer processor and a data repository in communication with the computer processor. The data repository stores a reference source. The data repository also stores an output of a primary large language model. The output includes sentences. The data repository also stores a first data structure including a first vector storing, for each of the sentences, a corresponding evaluation of a given sentence as being consistent or inconsistent with the reference source, and a corresponding reason for the corresponding evaluation of the given sentence. The data repository also stores a second data structure including a second vector storing scores indicating a corresponding consistency value for each of the sentences. The data repository also stores a metric indicating an overall consistency of the output with respect to the reference source. The system also includes a criteria model including a second large language model trained, when executed by the computer processor, to receive the output of the primary large language model and to compare each of the sentences to the reference source to generate the first data structure. The system also includes a converter model including a third large language model trained, when executed by the computer processor, to receive the first data structure and to convert the first data structure to the second data structure. The system also includes a server controller programmed, when executed by the computer processor, to generate the metric.

One or more embodiments also provide for a non-transitory computer readable storage medium storing program code which, when executed by a computer processor, performs a computer-implemented method. The computer-implemented method includes receiving an output of a primary large language model. The output includes sentences. The computer-implemented method also includes providing the output as a first input to a criteria model including a second large language model. The computer-implemented method also includes comparing, by the criteria model, each of the sentences to a reference source. As a result of comparing, the criteria model generates a second output including a first data structure including a first vector. The first vector stores, for each of the sentences, a corresponding evaluation of a given sentence as being consistent or inconsistent with the reference source, and a corresponding reason for the corresponding evaluation of the given sentence. The computer-implemented method also includes providing the second output to a converter model including a third large language model. The computer-implemented method also includes converting, by the converter model, the first data structure to a second data structure. The second data structure includes a second vector including scores indicating a corresponding consistency value for each of the sentences. The computer-implemented method also includes generating, from the second data structure, a metric indicating an overall consistency of the output with respect to the reference source.

Other aspects of one or more embodiments will be apparent from the following description and the appended claims.

### BRIEF DESCRIPTION OF DRAWINGS

FIG. 1A and FIG. 1B shows a computing system, in accordance with one or more embodiments.

FIG. 2A and FIG. 2B show methods, in accordance with one or more embodiments.

FIG. 3 shows an example of a dataflow for an improved automated evaluation of large language models, in accordance with one or more embodiments.

FIG. 4A, FIG. 4B, FIG. 4C, FIG. 4D, FIG. 4E, FIG. 4F, FIG. 4G, and FIG. 4H show another example of an architecture for an improved automated evaluation of large language models, in accordance with one or more embodiments.

FIG. 4I, FIG. 4J, FIG. 4K, FIG. 4L, FIG. 4M, and FIG. 4N show examples of different prompts used in the methods of FIG. 2A and FIG. 2B, and in the dataflow of FIG. 3, show an example of one or more embodiments in use, in accordance with one or more embodiments.

FIG. 4O and FIG. 4P show examples of evaluations according to the method of FIG. 2A and the dataflow of FIG. 3, in accordance with one or more embodiments.

FIG. 4Q shows an algorithm for a divide-conquer reasoning framework, such as in FIG. 1A, FIG. 3, or FIG. 4A, in accordance with one or more embodiments.

FIG. 5A and FIG. 5B show a computing system and network environment, in accordance with one or more embodiments.

Like elements in the various figures are denoted by like reference numerals for consistency.

### DETAILED DESCRIPTION

In general, one or more embodiments are directed to methods of an improved automated evaluation of large language models. Thus, one or more embodiments relate to techniques for detecting when a large language model generates an unexpected response to a prompt (e.g., techniques for detecting when the large language model “hallucinates.”)

One or more embodiments use a machine learning model ensemble to analyze the output of the primary large language model. The primary large language model is the model that is being observed and tested for unexpected results. The machine learning model ensemble includes at least a criteria model and a converter model.

The criteria model, which may be referred to as a divide-conquer evaluator, is a second large language model that is trained to perform semantic consistency checks between a reference source of information and the output of the primary large language model. The criteria model is programmed to analyze the output of the primary large language model on a sentence-by-sentence basis (as opposed to analyzing individual tokens, words, or paragraphs). Specifically, the criteria model checks each sentence of the output against the reference source to identify whether the sentence of the output is consistent with the reference source. The output of the criteria model includes an evaluation of consistency (e.g., consistent or not consistent) together with a reason for the evaluation.

The converter model, which may be referred to as an auto-metric converter, is a third large language model. The converter model is trained to take, as input, the output of the criteria model. The converter model generates, as output, a vector that represents quantitative assessments of the reasons (for consistency or inconsistency of the sentences in the primary model output) in a numeric score system. The converter model functions as a binary sentiment classifier that classifies the reasons to be either positive (“+1”) or negative (“−1”). A positive sentiment score indicates consistency of a sentence in the primary model's output with the source reference. A negative sentiment score indicates inconsistency of a sentence in the primary model's output with the source reference.

A consistency score is then generated from the vector output by the converter model. The consistency score may be deemed a comprehensive (e.g., overall) score that reflects an overall performance of the primary model with respect to the consistency of the output of the primary model with the source reference. If the consistency score satisfies a threshold value (e.g., falls below a threshold, meets the threshold, meets or exceeds the threshold, meets or is less than the threshold, etc.), then the output of the primary machine learning model is flagged as being inconsistent with the source reference.

Appropriate action may then be taken, such as by routing the output of the primary large language model. For example, the output of the primary machine learning model may be disregarded, and another large language model may be used to attempt to answer the same initial prompt provided to the primary machine learning model. In another example, an alert may be issued to a human agent, etc.

In still another example, the appropriate action may be to provide the metric and the output to a reason improver model. The reason improver model is yet another large language model that is trained to improve the consistency of candidate sentences by reasoning through the inconsistent explanations generated by the criteria model. The task of the reason improver model is to rewrite the original sentence(s) in the output and return a new output that includes the rewritten sentence(s). In an embodiment, the improved output can be re-checked by the criteria model and the process described above reiterated to ensure the consistency of the new output with the reference source. If the new output also includes one or more inconsistent sentences, then the overall process can be iterated yet again. The overall process can be iterated until the final output is consistent with the reference source.

Stated more formally, the technical problem may be described as follows. Given a user query Q and a large language model M, let C refer to the candidate response drawn from C=M(Q). The responses generated by M are commonly evaluated using some reference texts, denoted by R, for instance, human writing samples for generation tasks and original content for summarization tasks. The objective of the consistency evaluation is to build a function “f” that quantitatively measures the semantic equivalence S between the generated candidates C and reference R as S=f(R, C|Q, M) where S could be binary decision, such as “Yes” or “No,” “Consistent” or “Not Consistent,” or numeric score, e.g., [−1, +1].

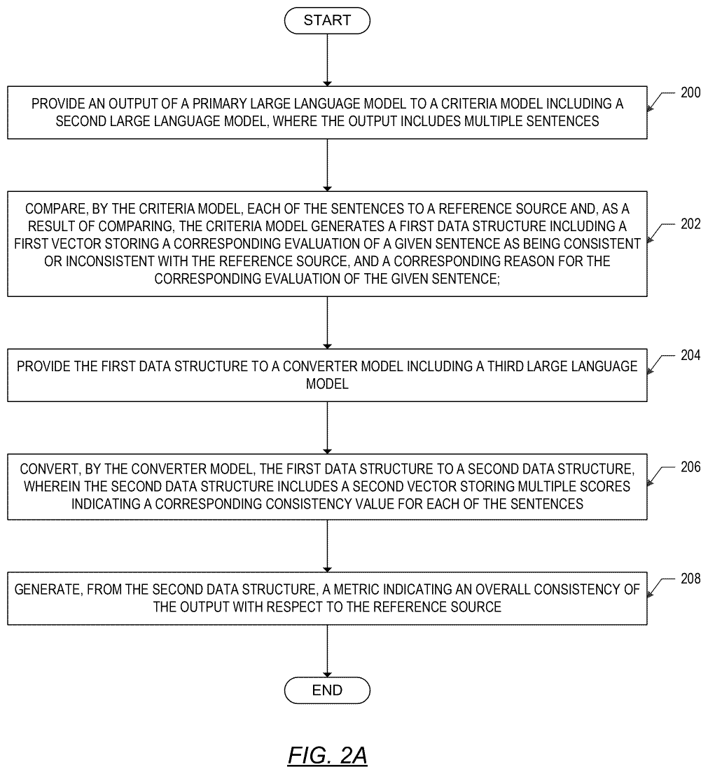

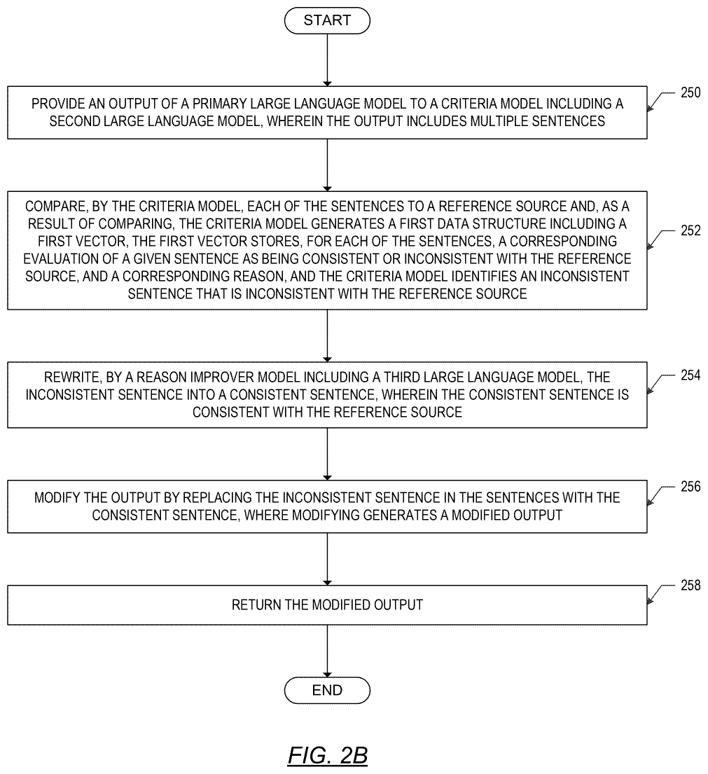

The technical solution is described above, and further with respect to FIG. 2A and FIG. 2B. Namely, one or more embodiments use a combination of a criteria model and a converter model to generate f and output the result of f. Then, a reason improver model may be used to improve the original output of the large language model M.

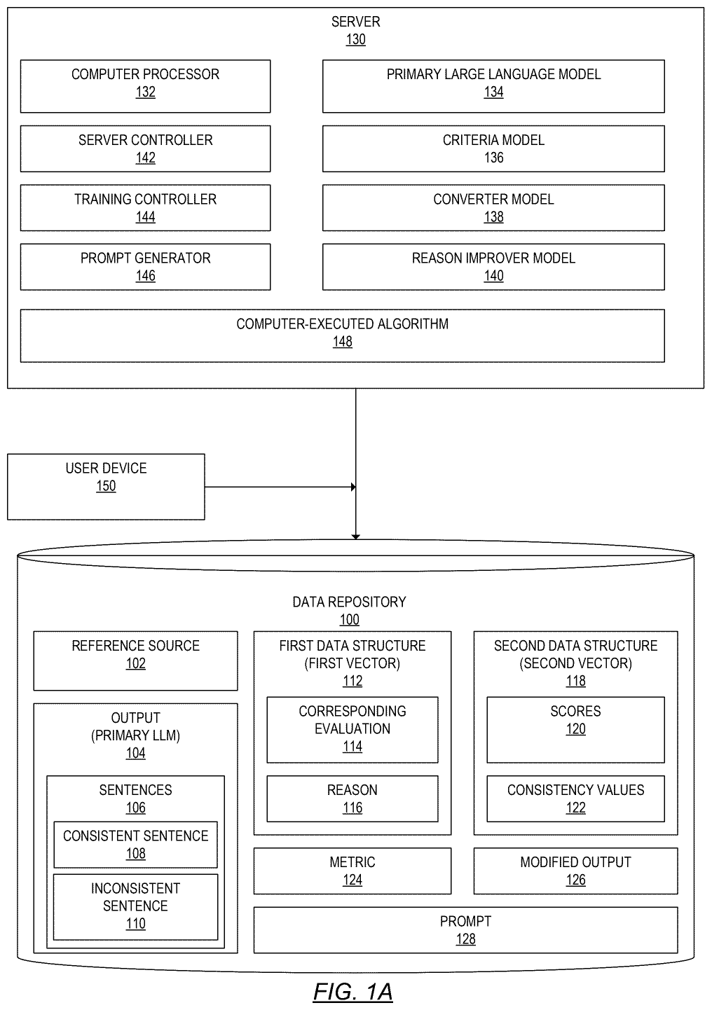

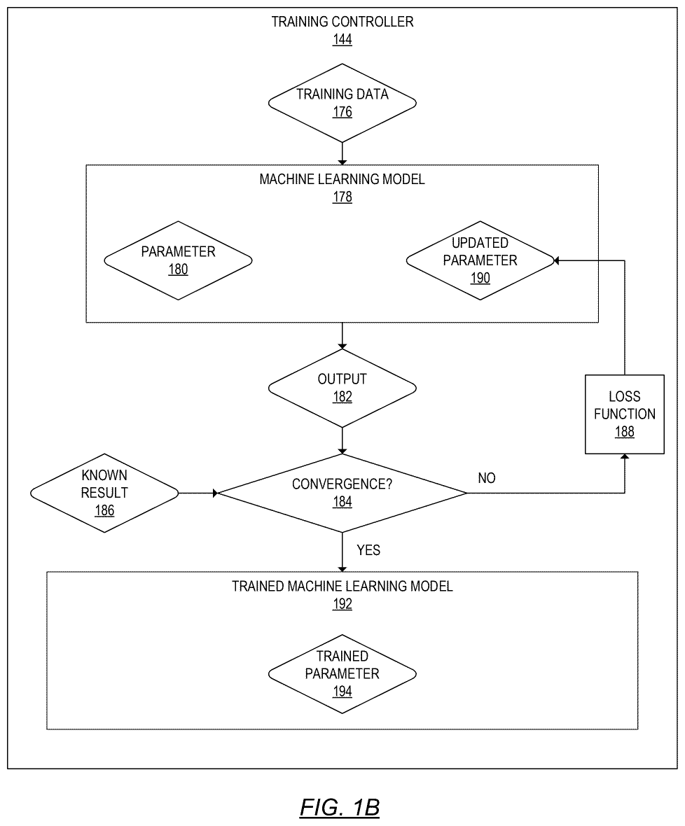

Attention is now turned to the figures. FIG. 1 shows a computing system, in accordance with one or more embodiments.

The system shown in FIG. 1 includes a data repository (100). The data repository (100) may be a storage unit and/or device (e.g., a file system, database, data structure, or any other storage mechanism) for storing data. Further, the data repository (100) may include multiple different, potentially heterogeneous, storage units and/or devices.

The data repository (100) stores a reference source (102). The reference source (102) is a source of natural language text (e.g., words, sentences, paragraphs) that are known to be correct. For example, the reference source (102) may be a context in a retrieval augmented generation model.

The data repository (100) also stores an output (104). The output (104) is an output of the primary large language model (134), defined below. Thus, the output (104) may be a candidate word, a candidate sentence, a candidate paragraph, or multiple instances or combinations thereof, which together may be referred to as candidate text. Candidate text is to be evaluated for being consistent with the reference source (102), as described with respect to FIG. 2.

The output (104) therefore may include one or more sentences (106). The sentences (106) may be a single sentence. The sentences (106) may include two or more words. The sentences (106) are an output of the output (104).

The sentences (106) may be either a consistent sentence (108) or an inconsistent sentence (110). A consistent sentence (108) is a sentence (i.e., one of the sentences (106)) that has a semantic meaning that is consistent with at least one reference sentence contained in the reference source (102), as determined by the techniques described with respect to FIG. 2A through FIG. 4P. An inconsistent sentence (110) is a sentence (i.e., one of the sentences (106)) that has a semantic meaning that is inconsistent with at least one reference sentence contained in the reference source (102), as determined by the techniques described with respect to FIG. 2A through FIG. 4P. However, to be inconsistent, the reference sentence is compared to a specific sentence in the reference source (102) that has been determined, or predetermined, to be related to the sentence under test.

The data repository (100) also stores a first data structure (112). The first data structure (112) is a vector. A vector is a computer readable data structure. A vector may take the form of a matrix, an array, a graph, or some other data structure. However, a frequently used vector form is a one by N matrix, where each cell of the matrix represents the value for one feature. As described above, a feature is a topic of data (e.g., a color of an object, the presence of a word or alphanumeric text, a physical measurement type, etc.). A value is a numerical or other recorded specification of the feature. For example, if the feature is the word “cat,” and the word “cat” is present in a corpus of text, then the value of the feature may be “1” (to indicate a presence of the feature in the corpus of text).

In particular, the first data structure (112) is an output of the criteria model (136), defined below. The first data structure (112) stores, for each of the sentences (106), a corresponding evaluation (114) of a given sentence as being consistent or inconsistent with the reference source (102). The first data structure (112) also stores, for each of the sentences (106), a corresponding reason (116) for the corresponding evaluation of the given sentence.

The corresponding evaluation (114) is part of the output of the criteria model (136). In particular, the evaluation is text or numbers that specify whether the candidate sentence (from among the sentences (106)) is consistent or inconsistent with a corresponding sentence in the reference source (102). In other words, the evaluation may be that the sentence in question is either a consistent sentence (108) or an inconsistent sentence (110).

The reason (116) is part of the output of the criteria model (136). The reason (116) is words or other text that specify the reason for why the corresponding evaluation (114) was applied to the corresponding evaluation (114). Operation of the criteria model (136) with respect to both the corresponding evaluation (114) and the reason (116) is described with respect to FIG. 2A through FIG. 4P.

The data repository (100) also may store a second data structure (118). The second data structure (118) is an output of the converter model (138) (which takes the first data structure (112) as input). The second data structure (118) stores one or more scores (120) and one or more corresponding consistency values (122). The scores (120) are numbers that indicate a corresponding consistent value (of the consistency values (122)) for each of the sentences (106) (on a sentence-by-sentence basis). Thus, the output of the converter model (138) includes a score, which is a consistency value for a corresponding sentence in the sentences (106). A sentence among the sentences (106) that is completely consistent with the reference source (102) may receive a value of “1,” and another sentence among the sentences (106) that is completely inconsistent with the reference source (102) may receive a value of “0.” Generation of the second data structure (118) is described with respect to FIG. 2A through FIG. 4P.

The data repository (100) also stores a metric (124). The metric (124) is a number or text that indicates an overall consistency of the output (104) of the primary large language model (134) with the reference source (102). Generation of the metric (124) is described with respect to FIG. 2A through FIG. 4P.

The data repository (100) also may store a modified output (126). The modified output (126) is text or numbers that is output by the reason improver model (140), described below. More specifically, the modified output (126) may be a rewritten version of an inconsistent sentence (110), which is rewritten to be consistent with the reference source (102). The modified output (126) may include multiple rewritten inconsistent sentences among the sentences (106). In other words, the modified output (126) is a modified version of the output (104) of the primary large language model (134).

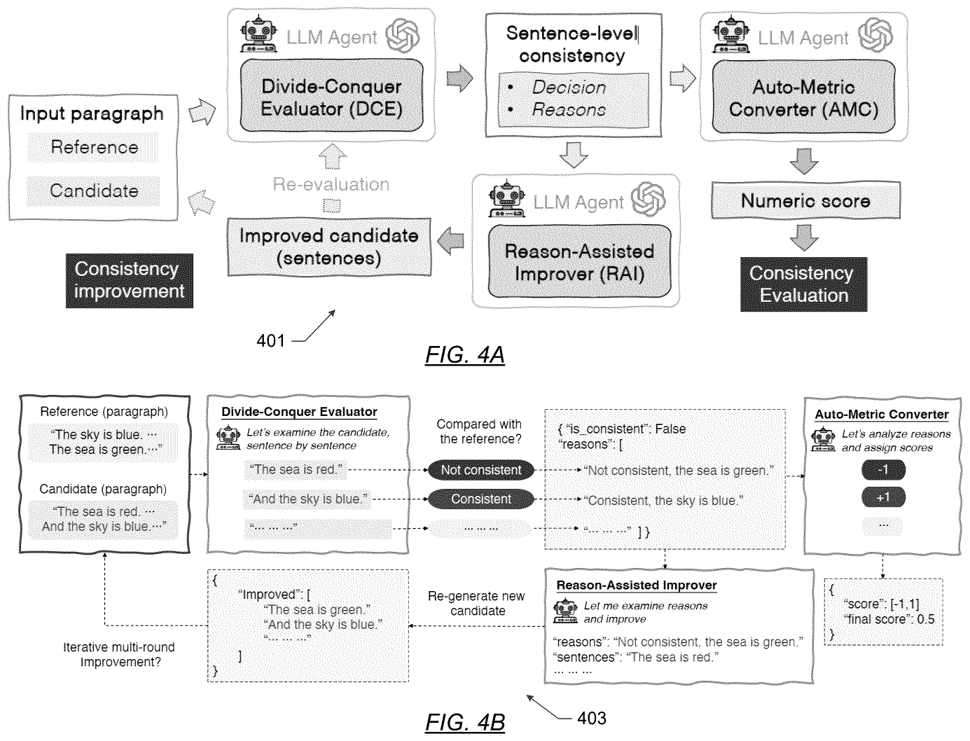

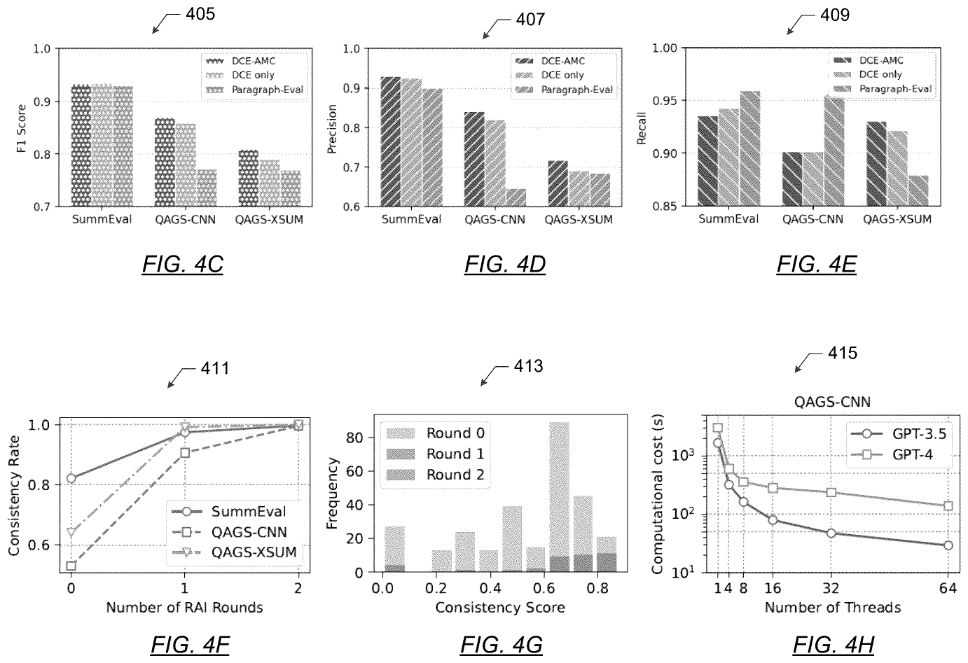

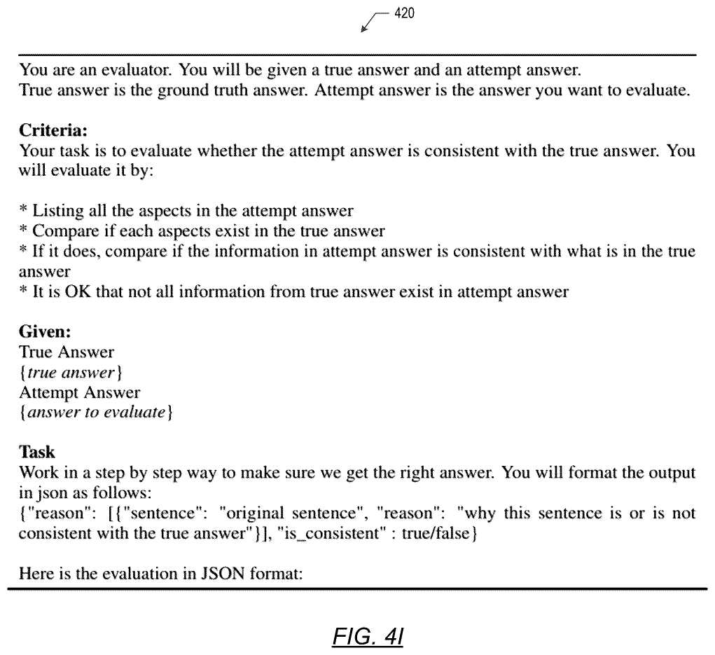

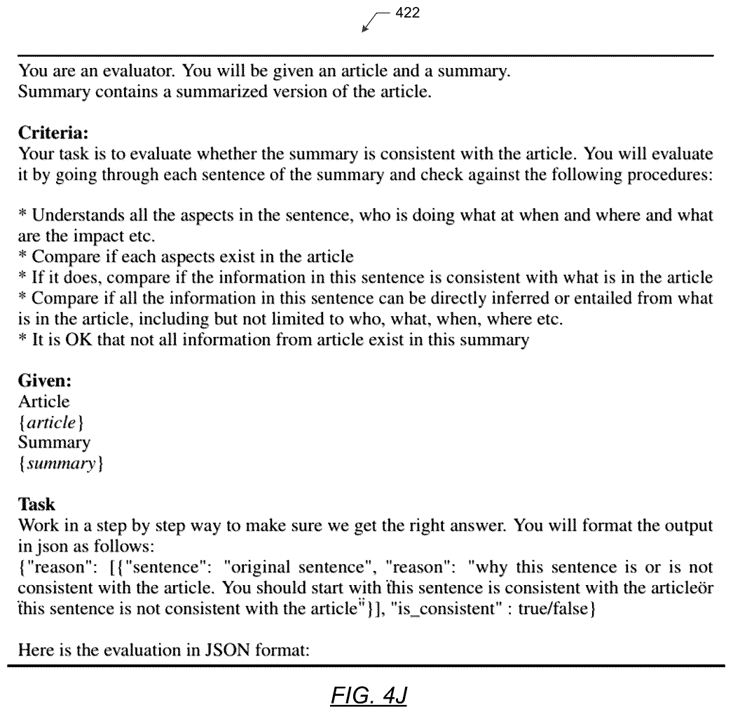

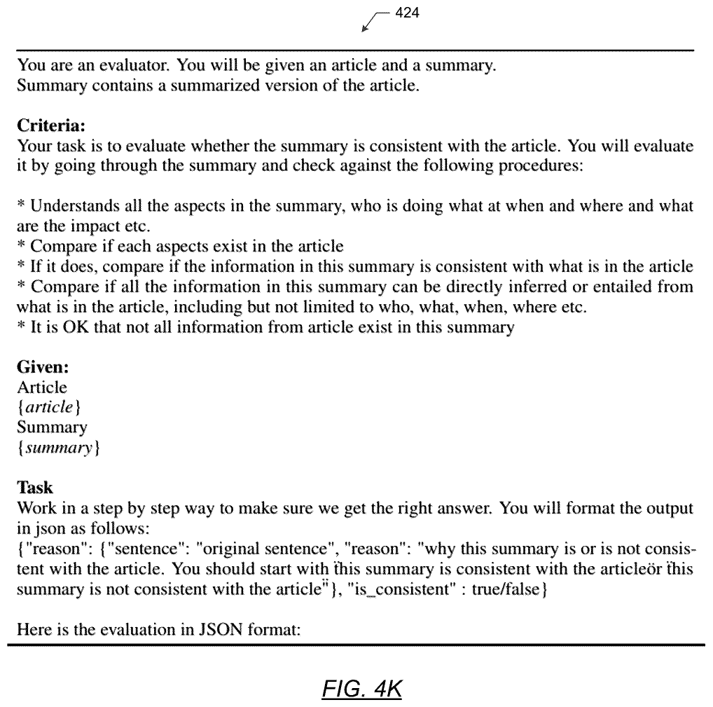

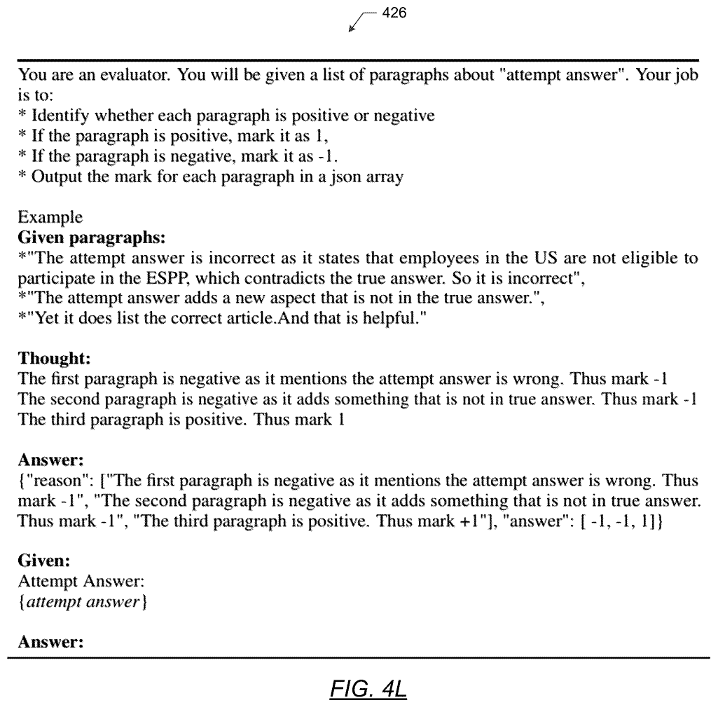

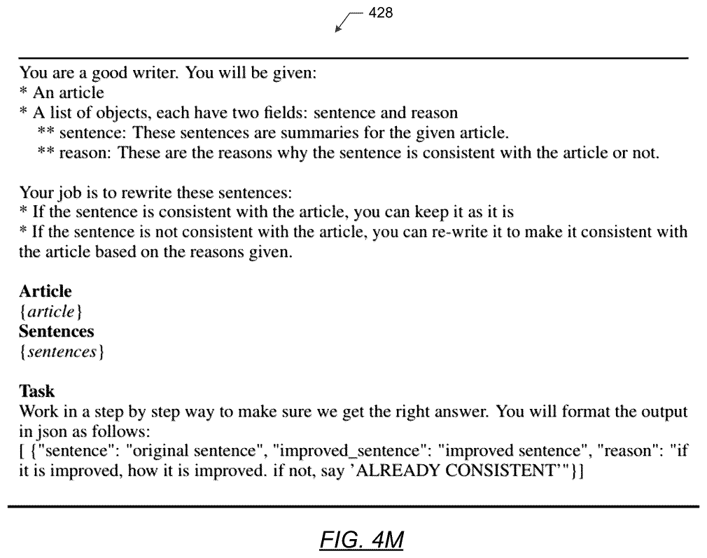

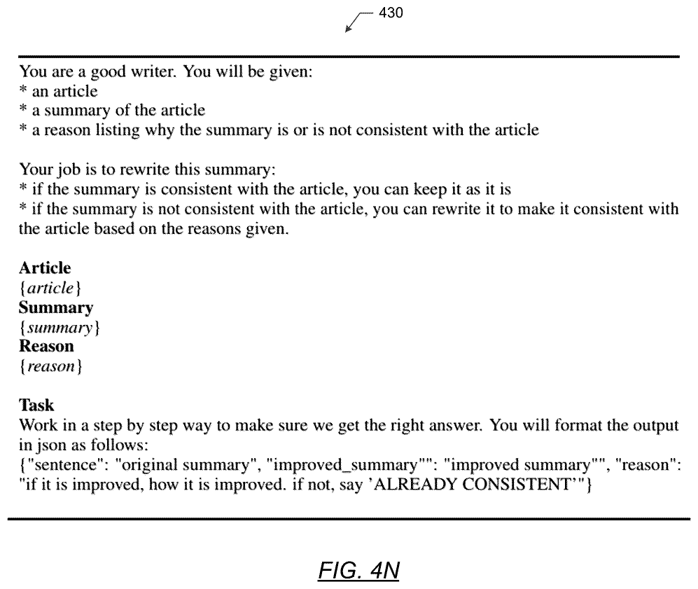

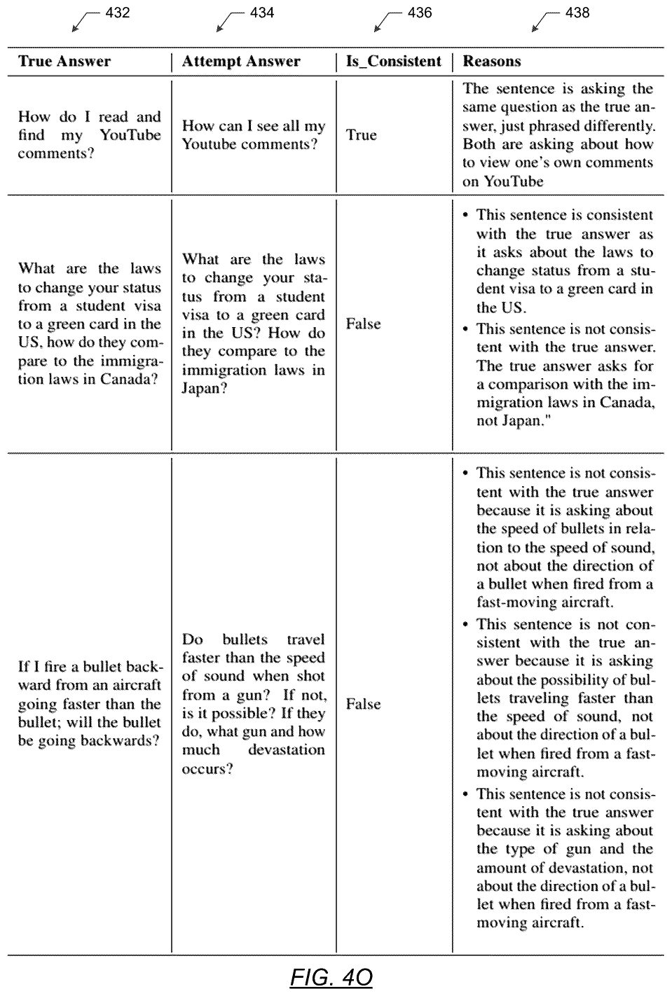

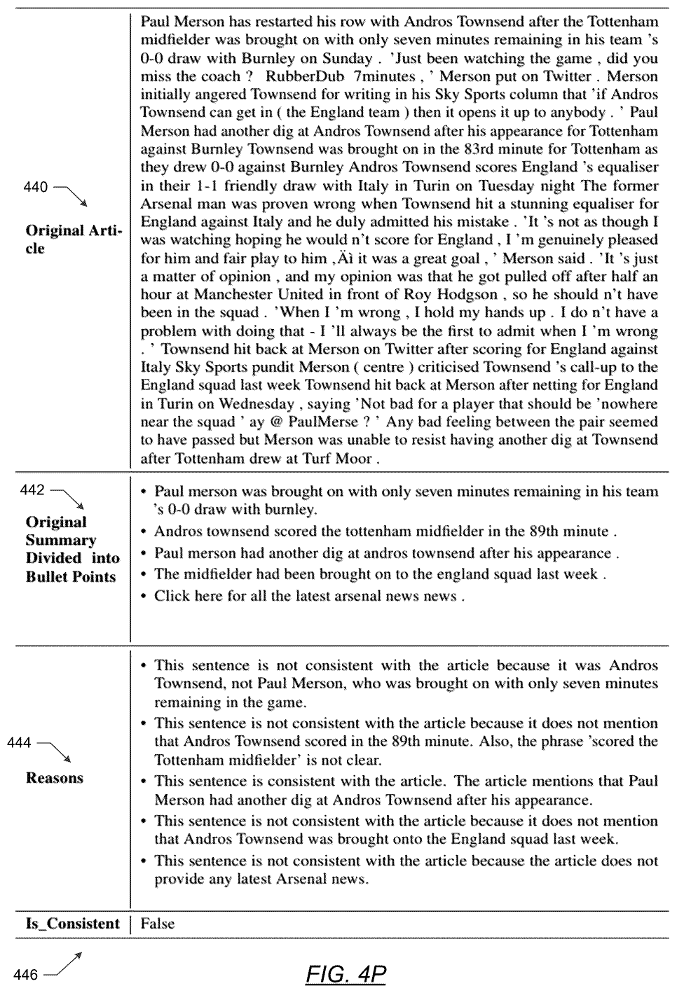

The data repository (100) also may store a prompt (128). The prompt (128) is a command to one or more of the language models described herein, such as the primary large language model (134), the criteria model (136), the converter model (138), or the reason improver model (140). The prompt (128) is expressed in terms of text. The prompt (128) is specific to the model in question and the steps in the methods of FIG. 2A and FIG. 2B. Examples of the prompt (128) for different models at different steps in the methods of FIG. 2A and FIG. 2B are shown in FIG. 4I through FIG. 4N.

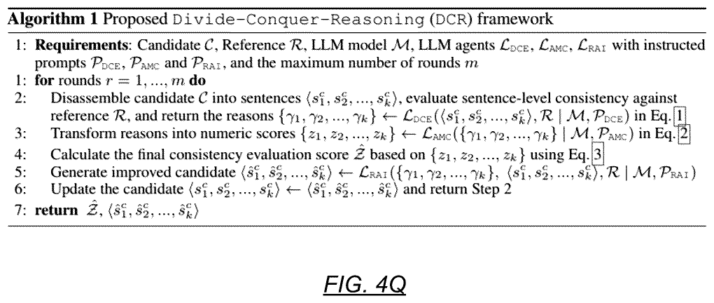

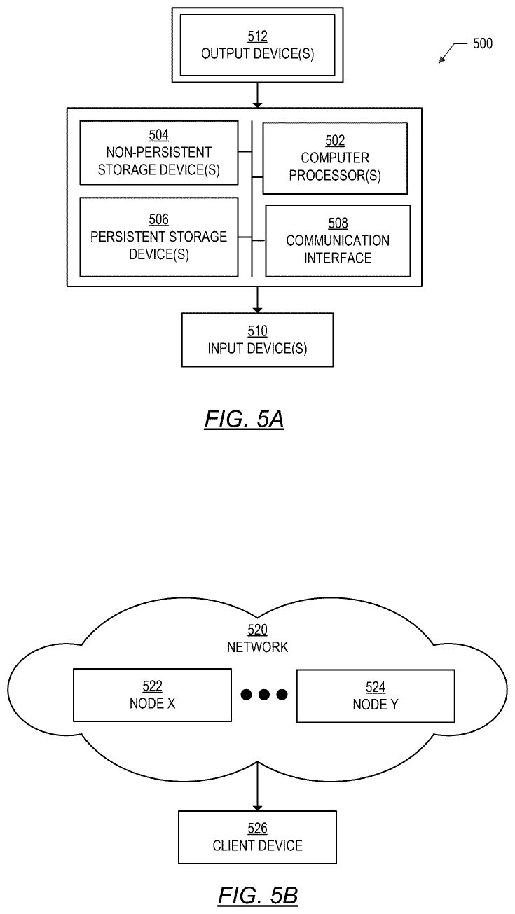

The system shown in FIG. 1 may include other components. For example, the system shown in FIG. 1 also may include a server (130). The server (130) is one or more computer processors, data repositories, communication devices, and supporting hardware and software. The server (130) may be in a distributed computing environment. The server (130) is configured to execute one or more applications, such as the criteria model (136), the converter model (138), the reason improver model (140), the server controller (142), the training controller (144), and the prompt generator (146). An example of a computer system and network that may form the server (130) is described with respect to FIG. 5A and FIG. 5B.

The server (130) includes a computer processor (134). The computer processor (134) is one or more hardware or virtual processors which may execute computer readable program code that defines one or more applications, such as the criteria model (136), the converter model (138), the reason improver model (140), the server controller (142), the training controller (144), and the prompt generator (146). An example of the computer processor (132) is described with respect to the computer processor(s) (502) of FIG. 5A.

The server (130) also may include a primary large language model (134). A large language model is a type of machine learning model that can process, understand, and generate human language. A large language model may be a type of neural network, for example. In an embodiment, the primary large language model (134) is not part of the server (130), in which case the output (104) is received from an external source (e.g., a user device (150)).

Large language models are termed “large” because large language models are trained on “large” datasets, e.g., billions of words. The term “large” in the term “large language model” is ascertainable to a computer scientist, but a large language model is trained on at least a billion words.

In one or more embodiments, the primary large language model (134) is “primary” because the primary large language model (134) is the model that is under evaluation. The primary large language model (134) generates the sentences (106) (e.g., a candidate paragraph that includes the sentences (106)).

The server (130) includes a criteria model (136). The criteria model (136) is a large language model that is trained to perform semantic consistency checks between the reference source (102) and the output (104) of the primary large language model (134). Thus, the criteria model (136) is trained to perform semantic consistency checks between the reference source (102) and a paragraph (composed of the sentences (106)) output by the primary large language model (134). The criteria model (136) is further trained to analyze any paragraph output by the output (104) on a sentence-by-sentence basis. In other words, the criteria model (136) is trained to break down an output paragraph into individual sentences that are then individually checked for consistency against the reference source (102). Further operation of the criteria model (136) is described with respect to FIG. 2A and FIG. 2B.

The server (130) also includes a converter model (138). The converter model (138) is a large language model that is trained to quantitatively measure the consistency evaluation derived from the criteria model (136). The converter model (138) operates by converting the reasons generated by the criteria model (136) into a numeric score system. The converter model (138) may be trained to perform as a binary classifier that classifies the reasons to be either positive (“1”) or negative (“−1”). Further operation of the criteria model (136) is described with respect to FIG. 2A and FIG. 2B.

The server (130) also includes a reason improver model (140). The reason improver model (140) is a large language model that is trained to improve the consistency of candidate sentences by reasoning through the inconsistent explanations generated by the criteria model (136). Thus, the reason improver model (140) is trained to generate new candidate sentences (i.e., an inconsistent sentence (110)) based on the reason or reasons why the inconsistent sentence (110) was inconsistent with the reference source (102) and based on the original output sentence of the primary large language model (134). The output of the reason improver model (140) may be a new sentence that is a consistent sentence (108), rather than an inconsistent sentence (110). However, the new sentence may be checked again by the criteria model (136), and the process repeated, as explained with respect to FIG. 2A and FIG. 2B.

One or more embodiments contemplate that the primary large language model (134), the criteria model (136), the converter model (138), and the reason improver model (140) are all the same large language model. In this case, the models are given different names only for purposes of making the dataflow of one or more embodiments clear.

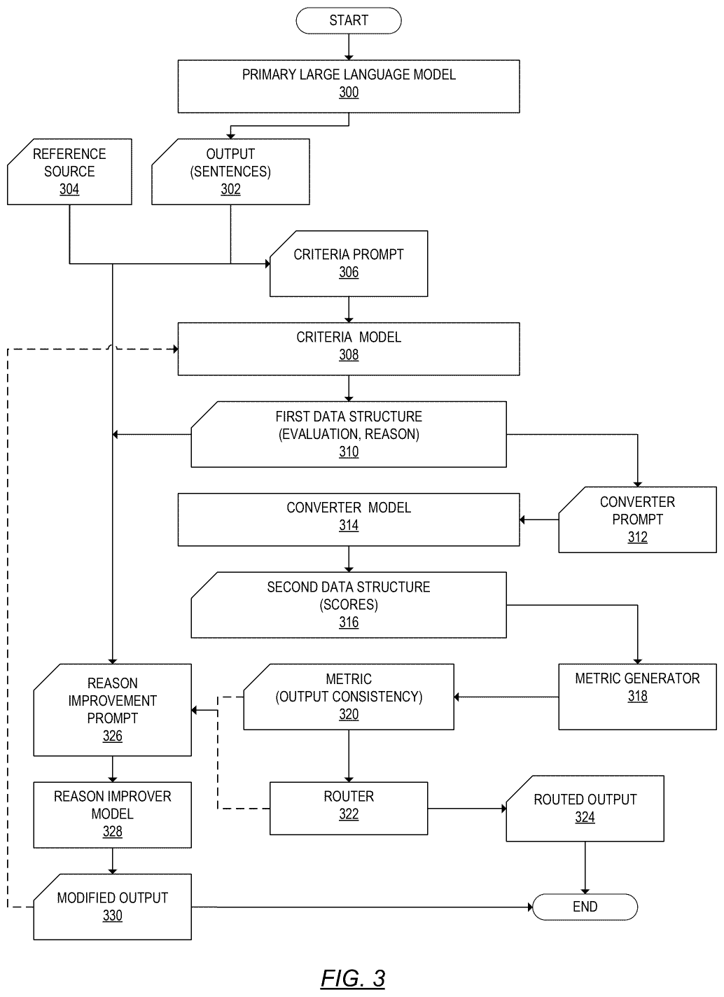

Further, the differences between the differently named models may lie in the different prompts that are input to the same large language model at different times in order to generate different results. Thus, referring to FIG. 3, the output sentences (302) are generated by a large language model in response to a command. Continuing the example, the criteria prompt (306) is input to the same large language model, but the criteria prompt (306) has different inputs (i.e., the reference source and the output sentences). Continuing the example, converter prompt (312) is input to the same large language model, but the converter prompt (312) has different inputs (i.e., first data structure (310)). Still continuing the example, the reason improvement prompt (326) is input to the same large language model, but the reason improvement prompt (326) has different inputs (i.e., the reference source (304), the output sentences (302), and the first data structure (310)).

However, one or more embodiments also contemplate that one or more of the criteria model (136), the converter model (138), and the reason improver model (140) are different large language models. Thus, for example, in FIG. 3, any of the primary large language model (300), the criteria model (308), the converter model (314), and the reason improvement model (326) may be different models. It is also possible that some of the models are the same large language model, but others of the models are different large language models.

The server (130) also includes a server controller (142). The server controller (142) is software or application specific hardware which, when executed by the computer processor (132), controls and coordinates operation of the software or application specific hardware described herein. Thus, the server controller (142) may control and coordinate execution of the method of FIG. 2A and FIG. 2B, or the dataflow of the example in FIG. 3. Hence, the modified output (126) may control the operation of the criteria model (136), the converter model (138), the reason improver model (140), and the prompt generator (146), together with manipulating any of the inputs and outputs thereof with respect to other processes.

The server (130) also may include a training controller (144). The training controller (144) is software or application specific hardware which, when executed by the computer processor (132), trains one or more untrained models (e.g., criteria model (136), the converter model (138), the reason improver model (140), or the prompt generator (146)). The training controller (144) is described in more detail with respect to FIG. 1B.

The server (130) also includes a prompt generator (146). The prompt generator (146) is software or application specific hardware which, when executed by the computer processor (132), generates the prompt (128). Examples of prompts for different stages of the methods described with respect to FIG. 2A and FIG. 2B are shown in FIG. 4I through FIG. 4N. In an embodiment, the prompt generator (146) may be software that, when executed by the computer processor (132) retrieves a prompt or a prompt template from a data repository (e.g., the data repository (100)) as part of generating the prompt (128).

The server (130) also may include a computer-executed algorithm (148). The computer-executed algorithm (148) is an algorithm that uses the modified output (126) to perform a function. For example, the computer-executed algorithm (148) may be a web browser or other application which may be used to control the operation of the method FIG. 2A or FIG. 2B. The computer-executed algorithm (148) also may be another language model which processes the modified output (126) for another purpose. For example, if the modified output (126) is a better summary of tax rules, then the computer-executed algorithm (148) may be a chatbot that returns the summary to a user of the user device (150). In another example, if the modified output (126) is an answer to a tax question, then the answer may be used by tax preparation software (i.e., the computer-executed algorithm (148) in this example) to automatically prepare a user's tax return.

Attention is turned to FIG. 1B, which shows the details of the training controller (144). The training controller (144) is a training algorithm, implemented as software or application specific hardware, that may be used to train one or more machine learning models, described with respect to the computing system of FIG. 1A.

In general, machine learning models are trained prior to being deployed. The process of training a model, briefly, involves iteratively testing a model against test data for which the final result is known, comparing the test results against the known result, and using the comparison to adjust the model. The process is repeated until the results do not improve more than some predetermined amount, or until some other termination condition occurs. After training, the final adjusted model (i.e., the trained machine learning model (192)) is applied to a new input vector in order to make predictions.

In more detail, training starts with training data (176) stored in a training data structure. The training data (176) is data for which the final result is known with certainty. For example, if the machine learning task is to identify whether two names refer to the same entity, then the training data (176) may be name pairs for which it is already known whether any given name pair refers to the same entity.

The training data (176) is provided as input to the machine learning model (178). The machine learning model (178), as described before, is an algorithm. However, the output of the algorithm may be changed by changing one or more parameters of the algorithm, such as the parameter (180) of the machine learning model (178). The parameter (180) may be one or more weights, the application of a sigmoid function, a hyperparameter, or possibly many different variations that may be used to adjust the output of the function of the machine learning model (178).

One or more initial values are set for the parameter (180). The machine learning model (178) is then executed on the training data (176). The result is an output (182), which is a prediction, a classification, a value, or some other output which the machine learning model (178) has been programmed to output.

The output (182) is provided to a convergence process (184). The convergence process (184) is programmed to achieve convergence during the training process. Convergence is a state of the training process, described below, in which a predetermined end condition of training has been reached. The predetermined end condition may vary based on the type of machine learning model being used (supervised versus unsupervised machine learning), or may be predetermined by a user (e.g., convergence occurs after a set number of training iterations, described below).

In the case of supervised machine learning, the convergence process (184) compares the output (182) to a known result (186). A determination is made whether the output (182) matches the known result (186) to a predetermined degree. The predetermined degree may be an exact match, a match to within a pre-specified percentage, or some other metric for evaluating how closely the output (182) matches the known result (186). Convergence occurs when the known result (186) matches the output (182) to within the predetermined degree.

In the case of unsupervised machine learning, the convergence process (184) may be to compare the output (182) to a prior output in order to determine a degree to which the current output changed relative to the immediately prior output or to the original output. Once the degree of change fails to satisfy a threshold degree of change, then the machine learning model may be considered to have achieved convergence. Alternatively, an unsupervised model may determine pseudo labels to be applied to the training data and then achieve convergence as described above for a supervised machine learning model. Other machine learning training processes exist, but the result of the training process may be convergence.

If convergence has not occurred (a “no” at the convergence process (184)), then a loss function (188) is generated. The loss function (188) is a program which adjusts the parameter (180) (one or more weights, settings, etc.) in order to generate an updated parameter (190). The basis for performing the adjustment is defined by the program that makes up the loss function (188). However, the basis also may be a scheme which attempts to guess how the parameter (180) may be changed so that the next execution of the machine learning model (178) using the training data (176) with the updated parameter (190) will have an output (182) that is more likely to result in convergence. (E.g., that the next execution of the machine learning model (178) is more likely to match the known result (186) (supervised learning), or which is more likely to result in an output that more closely approximates the prior output (one unsupervised learning technique), or which otherwise is more likely to result in convergence.)

In any case, the loss function (188) is used to specify the updated parameter (190). As indicated, the machine learning model (178) is executed again on the training data (176), this time with the updated parameter (190). The process of execution of the machine learning model (178), execution of the convergence process (184), and the execution of the loss function (188) continues to iterate until convergence.

Upon convergence (a “yes” result at the convergence process (184)), the machine learning model (178) is deemed to be a trained machine learning model (192). The trained machine learning model (192) has a final parameter, represented by the trained parameter (194). Again, the trained parameter (194) shown in FIG. 1B may be multiple parameters, weights, settings, etc.

During deployment, the trained machine learning model (192) with the trained parameter (194) is executed again, but this time on a new input vector for which the final result is not known. The output of the trained machine learning model (192) is then treated as a prediction of the information of interest relative to the unknown data.

While FIG. 1A and FIG. 1B show a configuration of components, other configurations may be used without departing from the scope of the invention. For example, various components may be combined to create a single component. As another example, the functionality performed by a single component may be performed by two or more components.

Attention is now turned to the methods of FIG. 2A and FIG. 2B. FIG. 2A may be characterized as a method of generating a metric that serves as a quantitative assessment of the consistency of the output of a large language model relative to a reference source, as defined with respect to FIG. 1A. The method of FIG. 2A may be performed using the system shown in FIG. 1A.

Step 200 includes providing an output of a primary large language model to a criteria model being a second large language model. The output includes a number of sentences.

Providing the output may be performed by executing the primary large language model on a query, and then routing the output of the primary large language model to be used as input in the criteria model. In an embodiment, the output of the primary large language model may be modified prior to input to the criteria model.

Step 202 includes comparing, by the criteria model, each of the sentences to a reference source. As a result of comparing, the criteria model generates a first data structure including a first vector. The first vector stores, for each of the sentences, a corresponding evaluation of a given sentence as being consistent or inconsistent with the reference source, and a corresponding reason for the corresponding evaluation of the given sentence.

The criteria model accepts a reference paragraph and a candidate paragraph as inputs, and employs a divide-conquer strategy to break down the entire paragraph into multiple individual sentences (divide) and then assess each sentence against the reference (conquer). More specifically, given the input reference R= [symbol] sr 1, . . . , sr 1 [symbol] and candidate C= [symbol] sc 1, . . . , sc k [symbol] , one or more embodiments provide a criteria model (LDCE) using the primary language model M (e.g., CHATGPT®) with an instructed prompt (PDCE) as:

$$\{ γ 1 , γ 2 , … , γ k \} = LDCE ( 〈 sc 1 , sc 2 , … , sck 〉 , R \vert M , PDCE ) . \qquad ( 1 )$$

Equation 1, above, generates reasons, denoted as Γ={γ1, γ2, . . . , γk}, which is a list of reasons explaining why each sentence “scᵢ” (i=1, 2, . . . , k) is or is not consistent against the entire reference paragraph R. Note that the reasons may be stored in the form of a first vector, as indicated above. The reasons γi might be a short paragraph containing multiple explanation sentences.

Thus, instruction prompts to LDCE may be crafted by defining task-specific criteria to accommodate different tasks. The prompt to the criteria model LDCE may be, for example, as follows (where “you” and “your” refer to the criteria model):
“Your task is to evaluate whether the summary is consistent with the article. You will evaluate it by going through each sentence of the summary and check against the following procedures: Understands all the aspects of the sentence, and compare if each aspect exists in the article; if it does, compare if the information in this sentence is consistent with what is in the article; compare if all the information in this sentence can be directly inferred or entailed from what is in the article. It is OK that not all information from the article exists in this summary.”

The prompt given above is an example only. Other prompts may be designed, depending on implementation specific examples.

Step 204 includes providing the first data structure to a converter model being a third large language model. Providing the first data structure may be performed by routing the output of the criteria model to the converter model. Thus, the output of the criteria model is the input to the converter model.

Step 206 includes converting, by the converter model, the first data structure to a second data structure. The second data structure includes a second vector storing scores indicating a corresponding consistency value for each of the sentences.

As defined with respect to FIG. 1, the converter model is a large language model that is trained to quantitatively measure the consistency evaluation derived from the criteria model by converting the reasons output from the criteria model into a numeric score system. The details of the operation of the converter model are now described.

The converter model may be designated as “LAMC.” The LAMC takes reasons [symbol] γ1, γ2, . . . , γk [symbol] with an instructed prompt (PAMC) as inputs:

$$\{ z 1 , z 2 , … , zk \} = LAMC ( \{ γ 1 , γ 2 , … , γ k \} \vert M , PAMC ) . \qquad ( 2 )$$

The converter model (LAMC) functions as a binary sentiment classifier that classifies the reasons [symbol] γ1, γ2, . . . , γk [symbol] to be either positive (marked by “+1” if the sentence is consistent), or negative (marked by “−1” otherwise). As a result, the output of the converter model (LAMC) is an array of scores {z1, z2, . . . , zk}, zi∈{−1, +1} for each sentence [symbol] sc 1, sc 2, . . . , sc k [symbol] in the candidate C.

Step 208 includes generating, from the second data structure, a metric indicating an overall consistency of the output with respect to the reference source. The metric may be generated as follows.

A score array is used to calculate a comprehensive score Z to evaluate how consistent the candidate (paragraph) is against the reference source. The score array may be defined by the following function.

$$Z = ( {\sum }_{i = 1}^{k} {z}_{i} + α ) / ( k + β ) , \hat{Z} = \frac{Z + 1}{2} , \hat{Z} ∈ [ 0 , 1 ] \qquad ( 3 )$$

In equation (3), k is the length of the score array (i.e., the number of sentences in the candidate paragraph). Depending on the prompt, the reasons output by the criteria model may not all be on the sentence level. To ensure that the score calculated is generated by sentence-level reasons, parameters α and β in equation (3), are introduced, as described below.

Stated differently terms α and β are added to force the criteria model to individually evaluate each sentence in the output of the primary large language model. As an example, suppose the output from the criteria model with a customized prompt is:

```
“{
    “is consistent” : False,
    “reasons” : [
      “The two paragraphs are not consistent.”,
      “This sentence is consistent.”
      “This sentence is not consistent.”
    ]
  }
```

After inspecting the reasons, one may see that the first entry is not a sentence level analysis, but a paragraph level analysis. Thus, when calculating scores one or more embodiments may remove the impact of the line.

Since, in this case, the first entry is negative, the first entry will be given “−1” score. Accordingly, the term a is set to “1” to mitigate the effect. Similarly, because one entry is not sentence level, the term p is set to “−1.” Thus for this particular case, equation 3, above, will be:

$$Z = ( {\sum }_{i = 1}^{k} {z}_{i} + 1 ) / ( k - 1 ) , \hat{Z} = \frac{Z + 1}{2} , \hat{Z} ∈ [ 0 , 1 ] \qquad ( 3 example )$$

Finally, Z is rescaled to obtain the final score \hat{Z} that is made to be between 0 (completely inconsistent) and 1 (completely consistent). The closer the score \hat{Z} is to 0, the more inconsistent the candidate C is against the reference R.

The method of FIG. 2A may be varied. For example, the method of FIG. 2A also may include routing the output of the primary large language model based on the metric. For example, routing may include transmitting, responsive to the metric satisfying a threshold, the output to a computer-executed algorithm. The computer-executed algorithm may then perform a specific task, such as to output an answer in a chatbot window, to provide an answer to tax preparation software, or to take some other action.

In another example, routing may include presenting, responsive to the metric satisfying a threshold, the output to a user. The user then may evaluate or use the answer, or submit a modified query. Thus, the method also may include transmitting, to a user device, the corresponding reason for display on the user device.

In still another example, routing may include deleting, responsive to the metric failing to satisfy a threshold, the output. In this case, the output may be regenerated using a reason improver model (see, for example, FIG. 2B).

Other variations are possible. For example, the method of FIG. 2A may further include retraining, responsive to the metric failing to satisfy a threshold, the primary large language model. The primary large language model may be trained by treating the outputs of the criteria model and the converter model, together with the corresponding output of the primary large language model, as additional training data. When the primary large language model is retrained using the additional training data, the parameters of the primary large language model may be improved to produce answers that are more consistent with the reference source. In this manner, the primary large language model may be transformed into an improved primary large language model.

Attention is now turned to FIG. 2B. FIG. 2B is a method of generating and returning a modified output once one or more of the sentences in the output of the primary large language model is determined to be inconsistent with the reference source. Thus, the method of FIG. 2B may be performed after the method of FIG. 2A. The method of FIG. 2B may be performed using the system of FIG. 1A.

Step 250 includes providing an output of a primary large language model to a criteria model being a second large language model. The output includes a number of sentences. The output may be provided by executing the primary large language model and then transmitting the output of the primary large language model as input to the criteria model. The output also may be provided by retrieving a previously generated output of a primary large language model. Thus, step 250 may be similar to step 200 of FIG. 2A.

Step 252 includes comparing, by the criteria model, the output to a reference source. As a result of comparing, the criteria model generates a first data structure including a first vector. The first vector stores, an evaluation of the output as being consistent or inconsistent with the reference source, and a corresponding reason for the corresponding evaluation. The criteria model identifies an inconsistent sentence, in the number of sentences, that is inconsistent with the reference source. Thus, step 252 may be similar to step 202 of FIG. 2A.

Step 254 includes rewriting, by a reason improver model being a third large language model, the inconsistent sentence into a consistent sentence. The consistent sentence is consistent with the reference source. Rewriting may be performed responsive to the metric satisfying a threshold value.

In an embodiment, rewriting may include the following sub-steps. First, a prompt is generated and the prompt is provided as input to the reason improver model, together with the inconsistent sentence. Generating the prompt includes defining a command to the reason improver model. Then the inconsistent sentence is added to the command. Then the corresponding reason for the inconsistent sentence is added to the command. Finally, a referral to the reference source is added to the command. When the large language model executes on the prompt, the output is a written sentence.

Stated more formally, the reason improver model (LRAI) is trained to generate new candidate sentences [symbol] , [symbol] , . . . , [symbol] based on the collected reasons {γ1, γ2, . . . , γk} and original sentences (s₁^{c}, s₂^{c}, . . . , sₖ^{c}) according to the following equation:

$$〈 , , … , 〉 = LRAI ( \{ γ 1 , γ 2 , … , γ k \} , 〈 {s}_{1}^{c} , {s}_{2}^{c} , … , {s}_{k}^{c} 〉 , R \vert M , PRAI ) . \qquad ( 4 )$$

The core task of the reason improver model (LRAI) is to rewrite the original sentence sᵢ^{c} if sᵢ^{c} is inconsistent with the reference R and return a new generated [symbol] ( [symbol] ≠sᵢ^{c}), otherwise retain sᵢ^{c}. The newly generated responses ĉ= [symbol] , [symbol] , . . . , [symbol] ) can be considered as the consistency-improved candidate, which can be reevaluated by the criteria model (DCE) to check if ĉ mitigates inconsistencies against the reference R.

The improved candidate ĉ in equation 4 can be directly fed to the criteria model in equation 1, above, after the first round of applying the three models, as in FIG. 2A and here in FIG. 2B. Thus, one or more embodiments contemplate a multi-round consistency improvement, where the consistency is iteratively improved until reaching the maximum number of rounds M.

Algorithm 1, shown in FIG. 4Q, illustrates the workflow of the DCR framework. The DCR framework includes three components: a DCE (the criteria model), an AMC (the converter model), and an RAI (the reason improver model).

Step 256 includes modifying the output by replacing the inconsistent sentence in the number of sentences with the consistent sentence. Thus, modifying generates a modified output (i.e., the replacement sentence is a consistent sentence, and the replacement sentence is the modified output). Replacing may be performed by removing the inconsistent sentence and adding, in place of the inconsistent sentence, the modified output (i.e., the consistent sentence).

Step 258 includes returning the modified output. Returning may include returning the modified output to the criteria model. In this case, the method of FIG. 2B also may include iterating comparing, rewriting, modifying, and returning until the output satisfies a predetermined criteria output by the criteria model.

In another embodiment, returning may include transmitting, to a user device, the modified output for presentation on the user device. The user then may take some other action, if desired.

Returning also may include returning the modified output to some other process. Thus, for example, the modified output may be used as described with respect to step 208 of FIG. 2A.

The method of FIG. 2B may be varied. For example, the method also may include providing the first data structure to a converter model being a fourth large language model. The converter model then converts the first data structure to a second data structure. The second data structure includes a second vector storing a number of scores indicating a corresponding consistency value for each of the number of sentences. The method then includes generating, from the second data structure, a metric indicating an overall consistency of the output with respect to the reference source. In this case, rewriting may be performed responsive to inputting the prompt to the reason improver model.

The method of FIG. 2B may include determining a corresponding evaluation for each of the sentences in an output of a primary machine learning model. The evaluation may be, on a sentence-by-sentence evaluation, whether a given sentence is consistent or inconsistent with a reference source. A reason also may be provided for each evaluation of the given sentence. Then, the method described herein may be iterated until all sentences in the output of the primary machine learning model are consistent with the reference source.

However, a similar improvement process may be performed based on an overall consistency score for the output of the machine learning model, rather than on evaluating consistency on a sentence-by-sentence basis as described above. For example, an overall consistency score and a reason for the consistency score (e.g., the overall consistency is 98.5% because 985 sentences out of 1000 sentences are consistent with the reference document(s)). As long as there exists a criteria to act upon, the “reason improver model” may continue to improve the output of the machine learning model. For example, the primary large language model output improvement process may continue until a threshold consistency score is reached (e.g., 99.5%), until one or more types of reasons exist or do not exist in the reason(s) output by the process described herein, or some other criteria. In other words, it is not necessary that perfect consistency be achieved before the iterative improvement process terminates.

Thus, one or more embodiments contemplate that iteration may continue until the output of the primary large language model satisfies a predetermined criteria output by the criteria model. The predetermined criteria may be the overall consistency score. The predetermined criteria may be the reason or absence of a reason output by the large language model. The predetermined criteria may be the number of sentences (from a set number of all sentences) that are determined to be consistent with the reference source. Other criteria also may be used.

In an embodiment, the method may include the following additional steps. The method also may include providing the first data structure to a converter model including a fourth large language model. The method also may include converting, by the converter model, the first data structure to a second data structure. The second data structure includes a second vector storing scores indicating a corresponding consistency value for each of the sentences. The method also may include generating, from the second data structure, a metric indicating an overall consistency of the output with respect to the reference source.

However, one or more embodiments also contemplate using other evaluation systems for large language model output consistency or model hallucination (unexpected large language model output) detection. For example, the output of the criteria model may be output to another evaluation system with a converter model to generate the consistency metric. Thus, different models may be used, other than those described herein.

FIG. 3 shows an example of a dataflow for an improved automated evaluation of large language models, in accordance with one or more embodiments. The dataflow of FIG. 3 may be performed using the system shown in FIG. 1A. The dataflow of FIG. 3 may be a variation of FIG. 2A and FIG. 2B.

Initially, a primary large language model (300) generates an output (302), which is composed of one or more sentences. In most cases, the output (302) is one or more paragraphs, each having multiple sentences.

The output (302) is used to generate a criteria prompt (306). The criteria prompt (306) also references a reference source (304). Examples of the criteria prompt (306) are shown in FIG. 4I, FIG. 4J, and FIG. 4K.

The criteria prompt (306) is provided as input to a criteria model (308). The criteria model (308) generates, as output, a first data structure (310). The first data structure (310) is an evaluation and a reason for each sentence in the output (302). The evaluation is a determination whether the corresponding sentence is consistent or inconsistent with the reference source (304). The reason is a reason why the sentence is consistent or inconsistent with the reference source (304). Note that, in many cases, the sentences in the output (302) are not compared on a one-to-one basis with sentences in the reference source (304). Rather, some or all reference sources (304) may be considered by the criteria model (308) when determining whether the output (302) is consistent with the reference source (304). However, the criteria prompt (306) could be commanded to perform a sentence-by-sentence comparison to specified individual sentences in the reference source (304), if desired.

The first data structure (310) is used in the generation of a converter prompt (312). The converter prompt (312) includes instructions to the converter model (314) to generate the second data structure (316). An example of the converter prompt (312) is shown in FIG. 4L.

The converter prompt (312) is provided as input to a converter model (314). The converter model (314) generates, as output, the second data structure (316). The second data structure (316) is a set of scores that indicate the consistency or inconsistency of each sentence in the output (302), relative to the reference source (304).

The scores are provided as input to a metric generator (318). The metric generator (318) generates combines the scores in the second data structure (316) to generate an overall metric (320). The metric (320) represents an overall consistency of the output (302).

The metric (320) is provided as input to a router (322). The router (322) routes the output (302) according to the metric (320). For example, if the metric (320) exceeds a threshold, then the router (322) routes the output (302) to a user or some other application. In this case, the routed output (324) is the output (302), and the process terminates.

However, if the metric (320) fails to satisfy a threshold, then the router (322) routes the output (302) to a reason improvement process. Specifically, a reason improvement prompt (326) is generated. Examples of the reason improvement prompt (326) are shown in FIG. 4M and FIG. 4N.

The reason improvement prompt (326) is provided as input to a reason improver model (328). The reason improver model (328) generates a modified output (330). The modified output (330) replaces inconsistent sentences in the criteria model (308) with new sentences that are, according to the reason improver model (328), consistent with the reference source (304).

However, optionally, the modified output (330) may be checked again. In this case, the modified output (330) may be provided back to the criteria model (308), and the dataflow repeats. Alternatively, or if the modified output (330) satisfies the threshold at metric (320), then the dataflow terminates.

Thus, FIG. 3 shows a dataflow representing a method of improving the output of the large language model by writing inconsistent sentences in the output of a large language model. An inconsistent sentence is inconsistent with the reference source. The rewritten sentences may be consistent with the reference source. To help ensure that all sentences of the output of the large language model are consistent with the reference source, the dataflow of FIG. 3 may be iterated. Thus, the output of the reason improver model may be input back to the criteria model as a new output. In this case, if more inconsistent sentences are found, then any such remaining inconsistent sentences are also rewritten sentences. The process continues to iterate until all sentences of the ultimate output are consistent with the reference source, or until the metric generated by a metric generator exceeds a threshold value.

Stated differently, the dataflow of FIG. 3 shows an evaluation and improvement to the consistency of a large language model output via a divide-conquer reasoning approach, referred to as DCR. The approach includes three components: a criteria model, a converter model, and a reason improver model. The criteria model may be referred to as a divide-conquer evaluator (DCE). The DCE disassembles the candidate paragraph and scrutinizes semantic inconsistencies sentence-by-sentence. The converter model may be referred to as an auto-metric converter (AMC). The AMC which converts sentence level inconsistency and consistency reasons into numeric scores for quantitative interpretation. The reason improver model may be referred to as a reason assisted improver (RAI). The RAI conducts analytical reasoning to improve consistency through candidate regeneration.

Thus, one or more embodiments involves a combination of sentence-level analysis, semantic consistency checking, and causal analysis, making one or more embodiments a useful evaluation metric for a diverse range of natural language tasks that apply comparison to reference texts, such as summarization, open-book question-answering (Q&A), and retrieval-augmented generation (RAG). Moreover, DCR not only evaluates but also improves the consistency of generated text through analysis and reasoning, which aligns with human intuition.

While the various steps in the flowcharts of FIG. 2A, FIG. 2B, and FIG. 3 are presented and described sequentially, at least some of the steps may be executed in different orders, may be combined or omitted, and at least some of the steps may be executed in parallel. Furthermore, the steps may be performed actively or passively.

The following examples are for explanatory purposes only and not intended to limit the scope of the invention. FIG. 4A shows an architecture of one or more embodiments, and is described in Exhibit A. FIG. 4B shows an example of the architecture of FIG. 4A in use, and is described in Exhibit A.

FIG. 4A, FIG. 4B, FIG. 4C, FIG. 4D, FIG. 4E, FIG. 4F, FIG. 4G, and FIG. 4H show quantification of the performance of the architecture shown in FIG. 4A, showing the improvement in the quality of the output of a large language model when the method of FIG. 3 is implemented. The quality is quantitatively defined as the metric determined by the method of FIG. 2 (i.e., the higher the metric score, the more consistent the output of the large language model is with respect to the reference source).

FIG. 4A shows an architecture and dataflow (401) of the criteria model (also referred to as a divide-and-conquer reasoner model), and thus shows an overview of a divide-and-conquer (DCR) framework, which is represented by the dataflow of FIG. 3. Thus, the architecture and dataflow (401) of FIG. 4A is a variation of FIG. 1A.

The first two components (DCE-AMC) provide a better strategy for evaluating and quantifying semantic consistency to best match human judgments. Building on the strategy, a third component RAI further utilizes analytical reasoning to iteratively improve the consistency of LLM-generated content with respect to the reference by minimizing hallucinations by up to sixty percent. The combination of DCE and AMC (DCE-AMC-4) significantly outperforms the baseline methods in terms of correlations with human ratings. The RAI substantially reduces output inconsistencies by about 90% through a single improvement iteration on predetermined benchmarks.

FIG. 4B shows an example (403) of evaluating and improving the consistency of generated text via the DCR according to the architecture and dataflow (401) shown in FIG. 4A. The text shown in the example indicates how the individual sentences of the output of the primary model are evaluated for consistency. The sentence that is inconsistent is replaced with a sentence that is consistent with the reference source.

FIG. 4C shows a graph (405) of score performance of one or more embodiments on sentence-level and paragraph level evaluations and an auto-metric converter. FIG. 4D shows a graph (407) of precision performance of one or more embodiments on sentence-level and paragraph level evaluations and an auto-metric converter. FIG. 4E shows a graph (409) of recall performance of one or more embodiments on sentence-level and paragraph level evaluations and an auto-metric converter.

Together, FIG. 4C, FIG. 4D, and FIG. 4E show F1 score, precision, and recall performance of one or more embodiments on sentence-level and paragraph level evaluations. The effectiveness of the converter model is also verified.

FIG. 4F shows a graph (411) showing a multi-round consistency improvement in terms of a consistency rate versus a number of rounds that the reason improver model was iterated. FIG. 4G shows a graph (413) showing a multi-round consistency improvement in terms of a frequency distribution of the consistency score versus the consistency score. FIG. 4H shows a graph (415) showing an improvement in computational cost when using one or more embodiments in terms of the computational cost versus a number of computing threads engaged.

Together, FIG. 4F, FIG. 4G, and FIG. 4H show a multi-round consistency improvement in the final output, as revised by the reason improver model. FIG. 4H, in particular, shows the computational cost of performing the dataflow of one or more embodiments (e.g., the dataflow of FIG. 3). A clear reduction in computational cost is observed as the number of threads increases. Note that the decrease in time is more significant when transitioning from a single thread to four threads, but tends to plateau as more threads are utilized.

FIG. 4I, FIG. 4J, FIG. 4K, FIG. 4L, FIG. 4M, and FIG. 4N show examples of different prompts used in the methods of FIG. 2A and FIG. 2B, and in the dataflow of FIG. 3, in accordance with one or more embodiments. In each of the prompts shown in FIG. 4I through FIG. 4N, the word “you” refers to the large language model in question (i.e., the term “you” informs the large language model that the large language model is instructed to behave in a certain way).

FIG. 4I shows a prompt (420). The prompt (420) may be characterized as a semantic consistency evaluator prompt. Thus, the prompt (420) is suitable for use with the criteria model described above.

FIG. 4J shows a prompt (422). The prompt (422) may be characterized as a summarization consistency evaluator prompt. Thus, the prompt (422) is suitable for use with the criteria model described above.

FIG. 4K shows a prompt (424). The prompt (424) may be characterized as a paragraph level evaluator prompt. Thus, the prompt (424) is suitable for use with the criteria model described above.

FIG. 4L shows a prompt (426). The prompt (426) may be characterized as an auto-metric converter prompt. Thus, the prompt (426) is suitable for use with the converter model described above.

FIG. 4M shows a prompt (428). The prompt (428) may be characterized as a reason assisted improver prompt. Thus, the prompt (428) is suitable for use with the reason improver model described above.

FIG. 4N shows a prompt (430). The prompt (430) may be characterized as a paragraph level reason assisted improver prompt. Thus, the prompt (430) is suitable for use with the reason improver model described above.

FIG. 4O and FIG. 4P show examples of evaluations according to the method of FIG. 2A and the dataflow of FIG. 3, in accordance with one or more embodiments. In FIG. 4O, column (432) shows the true answers (i.e., sentences contained in a reference source that are taken to be true). Column (434) shows the attempted answer (i.e., sentences output by the primary large language model). Column (436) shows a determination, by the criteria model, whether the attempted answer in column (434) is consistent with the true answer in column (432). Column (438) shows the reasons, as generated by the criteria model, why the attempted answer in column (434) is consistent—or inconsistent—with the true answer in column (432).

FIG. 4P shows another example evaluation on a different primary large language model output, and evaluated using a different criteria model. The “correct” answers are contained in the original article (440), which is the reference source. The output of the primary large language model is the original summary (442), divided into bullet points (as commanded by an initial prompt to the primary large language model to summarize the 440). The reasons (444) why the original summary (442) is consistent or inconsistent with the original article (440) are provided as shown. As indicated, the determination (446) of the criteria model is that the original summary (442) is inconsistent with the original article (440) (again, for the reasons (444) shown).

FIG. 4Q shows an algorithm for a divide-conquer reasoning framework, such as in FIG. 1, FIG. 3, or FIG. 4A, in accordance with one or more embodiments. The DCR framework includes three components: a DCE (the criteria model), an AMC (the converter model), and an RAI (the reason improver model). The DCR framework refers to the overall architecture and dataflow, as represented by FIG. 1, FIG. 2A, FIG. 2B, and FIG. 3. The steps shown in FIG. 4Q indicate the order of operations. Reference is made to the equations defined above with respect to FIG. 2A and FIG. 2B.

Embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure. For example, as shown in FIG. 5A, the computing system (500) may include one or more computer processors (502), non-persistent storage (504), persistent storage (506), a communication interface (508) (e.g., Bluetooth interface, infrared interface, network interface, optical interface, etc.), and numerous other elements and functionalities that implement the features and elements of the disclosure. The computer processor(s) (502) may be an integrated circuit for processing instructions. The computer processor(s) may be one or more cores or micro-cores of a computer processor. The computer processor(s) (502) includes one or more computer processors. The one or more computer processors may include a central processing unit (CPU), a graphics processing unit (GPU), a tensor processing units (TPU), combinations thereof, etc.

The input devices (510) may include a touchscreen, keyboard, mouse, microphone, touchpad, electronic pen, or any other type of input device. The input devices (510) may receive inputs from a user that are responsive to data and messages presented by the output devices (512). The inputs may include text input, audio input, video input, etc., which may be processed and transmitted by the computing system (500) in accordance with the disclosure. The communication interface (508) may include an integrated circuit for connecting the computing system (500) to a network (not shown) (e.g., a local area network (LAN), a wide area network (WAN) such as the Internet, mobile network, or any other type of network) and/or to another device, such as another computing device.

Further, the output devices (512) may include a display device, a printer, external storage, or any other output device. One or more of the output devices may be the same or different from the input device(s). The input and output device(s) may be locally or remotely connected to the computer processor(s) (502). Many different types of computing systems exist, and the aforementioned input and output device(s) may take other forms. The output devices (512) may display data and messages that are transmitted and received by the computing system (500). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a computer processor(s), is configured to perform one or more embodiments, which may include transmitting, receiving, presenting, and displaying data and messages described in the other figures of the disclosure.

The computing system (500) in FIG. 5A may be connected to or be a part of a network. For example, as shown in FIG. 5B, the network (520) may include multiple nodes (e.g., node X (522), node Y (524)). Each node may correspond to a computing system, such as the computing system shown in FIG. 5A, or a group of nodes combined may correspond to the computing system shown in FIG. 5A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (500) may be located at a remote location and connected to the other elements over a network.

The nodes (e.g., node X (522), node Y (524)) in the network (520) may be configured to provide services for a client device (526), including receiving requests and transmitting responses to the client device (526). For example, the nodes may be part of a cloud computing system. The client device (526) may be a computing system, such as the computing system shown in FIG. 5A. Further, the client device (526) may include and/or perform all or a portion of one or more embodiments.

The computing system of FIG. 5A may include functionality to present raw and/or processed data, such as results of comparisons and other processing. For example, presenting data may be accomplished through various presenting methods. Specifically, data may be presented by being displayed in a user interface, transmitted to a different computing system, and stored. The user interface may include a GUI that displays information on a display device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be temporary, permanent, or semi-permanent communication channel between two entities.

The various descriptions of the figures may be combined and may include or be included within the features described in the other figures of the application. The various elements, systems, components, and steps shown in the figures may be omitted, repeated, combined, and/or altered as shown from the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, or is an “inclusive or” and, as such includes “and.” Further, items joined by an or may include any combination of the items with any number of each item unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
providing an output of a primary large language model to a criteria model comprising a second large language model, wherein the output comprises a plurality of sentences;
comparing, by the criteria model, each of the plurality of sentences to a reference source, wherein:
as a result of comparing, the criteria model generates a first data structure comprising a first vector, and
the first vector stores, for each of the plurality of sentences, a corresponding evaluation of a given sentence as being consistent or inconsistent with the reference source, and a corresponding reason for the corresponding evaluation of the given sentence;
providing the first data structure to a converter model comprising a third large language model;
converting, by the converter model, the first data structure to a second data structure, wherein the second data structure comprises a second vector storing a plurality of scores indicating a corresponding consistency value for each of the plurality of sentences; and
generating, from the second data structure, a metric indicating an overall consistency of the output with respect to the reference source.

2. The method of claim 1, further comprising:
routing the output based on the metric.

3. The method of claim 2, wherein routing further comprises:
transmitting, responsive to the metric satisfying a threshold, the output to a computer-executed algorithm.

4. The method of claim 2, wherein routing further comprises:
presenting, responsive to the metric satisfying a threshold, the output to a user.

5. The method of claim 2, wherein routing further comprises:
deleting, responsive to the metric failing to satisfy a threshold, the output; and
regenerating the output using a reason improver model.

6. The method of claim 1, further comprising:
retraining, responsive to the metric failing to satisfy a threshold, the primary large language model.

7. The method of claim 1, further comprising:
transmitting, to a user device, the corresponding reason for display on the user device.

8. A system comprising:
a computer processor;
a data repository in communication with the computer processor, wherein the data repository stores:
a reference source,
an output of a primary large language model, wherein the output comprises a plurality of sentences,
a first data structure comprising a first vector storing, for each of the plurality of sentences, a corresponding evaluation of a given sentence as being consistent or inconsistent with the reference source, and a corresponding reason for the corresponding evaluation of the given sentence,
a second data structure comprising a second vector storing a plurality of scores indicating a corresponding consistency value for each of the plurality of sentences, and
a metric indicating an overall consistency of the output with respect to the reference source;
a criteria model comprising a second large language model trained, when executed by the computer processor, to receive the output of the primary large language model and to compare each of the plurality of sentences to the reference source to generate the first data structure;
a converter model comprising a third large language model trained, when executed by the computer processor, to receive the first data structure and to convert the first data structure to the second data structure; and
a server controller programmed, when executed by the computer processor, to generate the metric.

9. The system of claim 8, further comprising:
the primary large language model.

10. The system of claim 8, wherein the server controller is further programmed to route the output based on the metric.

11. The system of claim 10, wherein routing further comprises:
transmitting, responsive to the metric satisfying a threshold, the output to a computer-executed algorithm.

12. The system of claim 10, wherein routing further comprises at least one of:
presenting, responsive to the metric satisfying a threshold, the output to a user device; or
deleting, responsive to the metric failing to satisfy the threshold, the output; and
regenerating the output using a reason improver model.

13. The system of claim 8, wherein the primary large language model, the criteria model, and the converter model comprise a single machine learning model that receives different prompts.

14. The system of claim 8, further comprising:
a training controller programmed, when executed by the computer processor, to retrain the primary large language model, responsive to the metric failing to satisfy a threshold.

15. The system of claim 8, further comprising:
a communication device for transmitting, to a user device, the corresponding reason.

16. A non-transitory computer readable storage medium storing program code which, when executed by a computer processor, performs a computer-implemented method comprising:
receiving an output of a primary large language model, wherein the output comprises a plurality of sentences;
providing the output as a first input to a criteria model comprising a second large language model;
comparing, by the criteria model, each of the plurality of sentences to a reference source, wherein:
as a result of comparing, the criteria model generates a second output comprising a first data structure comprising a first vector, and
the first vector stores, for each of the plurality of sentences, a corresponding evaluation of a given sentence as being consistent or inconsistent with the reference source, and a corresponding reason for the corresponding evaluation of the given sentence;
providing the second output to a converter model comprising a third large language model;
converting, by the converter model, the first data structure to a second data structure, wherein the second data structure comprises a second vector comprising a plurality of scores indicating a corresponding consistency value for each of the plurality of sentences; and
generating, from the second data structure, a metric indicating an overall consistency of the output with respect to the reference source.

17. The non-transitory computer readable storage medium of claim 16, wherein the computer-implemented method further comprises:
routing the output based on the metric.

18. The non-transitory computer readable storage medium of claim 17, wherein routing further comprises one of:
transmitting, responsive to the metric satisfying a threshold, the output to a computer-executed algorithm;
presenting, responsive to the metric satisfying the threshold, the output to a user; and
deleting, responsive to the metric failing to satisfy the threshold, the output; and
regenerating the output using a reason improver model.

19. The non-transitory computer readable storage medium of claim 16, wherein the computer-implemented method further comprises:
retraining, responsive to the metric failing to satisfy a threshold, the primary large language model.

20. The non-transitory computer readable storage medium of claim 16, wherein the computer-implemented method further comprises:
transmitting, to a user device, the corresponding reason for display on the user device.
